(19) United States
(12) Patent Application Publication
(10) Pub. No.: US 2004/0179932 A1
(43) Pub. Date: Sep. 16, 2004

(54) Robotic hand with multi-wafer end effector

(76) Inventors: Jaswant Sandhu, Aloha, OR (US); Toshi Kono, Fairview, OR (US); Osamu Komiyaji, Fairview, OR (US); Robert Hosack, Vancouver, WA (US); Keith Berdogin, Keizer, OR (US); Neal Martin, Portland, OR (US)

Correspondence Address: MARGER JOHNSON & MCCOLLOM PC, 1030 SW MORRISON STREET, PORTLAND, OR, 97205, US

(21) Appl. No.: 10/815,428

(22) Filed: Mar. 31, 2004

Related U.S. Application Data
(62) Division of application No. 10/202,401, filed on Jul. 22, 2002.

(51) Int. Cl. B66C 23/00

(52) U.S. Cl. 414/811

(57) ABSTRACT

A robot constructed according to the present disclosure is adapted to grasp and move a plurality of wafers simultaneously. Such robot includes movable arm and wrist rotatably mounted thereto, with a multi-wafer robotic hand coupled to the wrist of the robot. Wafers can be transferred by inserting end effectors between the wafers in a receptacle, grasping the desired wafers, relocating the hand to another wafer receptacle, and releasing of the wafers into the second receptacle.

### BACKGROUND OF THE INVENTION

The present invention is related to the field of wafer handling devices, and more specifically to a robotic hand adapted to grasp and move a plurality of wafers simultaneously.

In semiconductor fabrication, silicon wafers are subjected to a variety of processes. Movement of wafers between processing stations (e.g., holding stations, washing stations and the like) is preferably automated and is undertaken by robots, to increase throughput and minimize risk of contamination.

The diameter of wafers also has been steadily increasing in recent years. The current wafer size commonly used is 300 mm, with larger wafers expected in the near future.

As wafers grow larger, the workspace required for processing increases exponentially, prompting effort to minimize the increase in equipment footprint. To increase throughput, it is further advantageous to be able to move wafers in groups rather than individually. As a further effort to minimize the impact of wafer size on workspace requirements, wafer receptacles have been designed to receive and hold wafers with less inter-wafer space or pitch. The wafer pitch currently used in the industry is 10 mm.

End effectors are known in the art for use in grasping and moving silicon wafers used in semiconductor fabrication. Such end effectors typically grasp wafers by mechanical means, such as friction or a vacuum applied to the wafer underside.

A device structured to grasp and move a plurality of wafers must accommodate the wafer pitch of the receptacle, i.e., have end effectors configured to fit between the wafers in the receptacle without unintentionally contacting the receptacle or the edges or surfaces of the wafers therein. These wafer pitch requirements place design constraints on the mechanical structure of such a device.

As well, workspace area reduction places the various processing stations in closer proximity. A multi-wafer handling robot therefore should be able to move a plurality of wafers in a variety of axes to transfer wafers from one receptacle to another within a smaller footprint.

The robot and hand disclosed herein will become more readily apparent from the following detailed description, which proceeds with reference to the drawings, in which:

### BRIEF DESCRIPTION OF THE DRAWINGS

FIG. 1 is a diagram showing a robot having a hand structured to grasp and move a plurality of wafers simultaneously, constructed in accordance with the present disclosure.

FIG. 2 is a perspective view of a multi-wafer robotic hand as disclosed herein.

FIG. 3 is an enlarged exploded view of one embodiment of the hand shown in FIG. 2.

FIGS. 4-5 are top and side views, respectively, of the hand shown in FIG. 2 with a plurality of wafers grasped thereby.

### DETAILED DESCRIPTION OF PREFERRED EMBODIMENT(S)

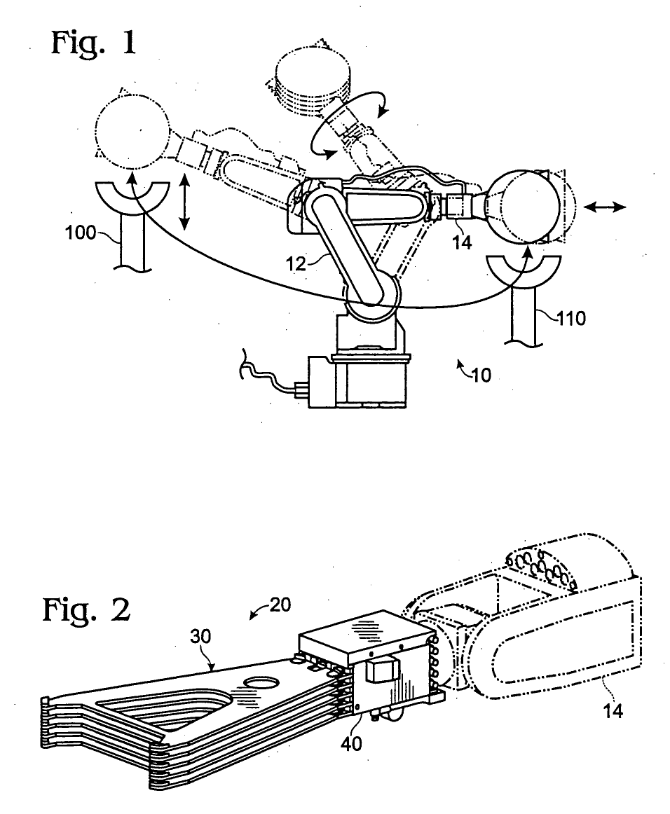

Looking first at FIGS. 1 and 2, a robot 10 constructed according to the present disclosure is adapted to grasp and move a plurality of wafers simultaneously, for example in a semiconductor fabrication facility. Robot 10 includes a movable arm 12 and a wrist 14 rotatably mounted thereto. A multi-wafer robotic hand 20 is coupled to wrist 14 of robot 10.

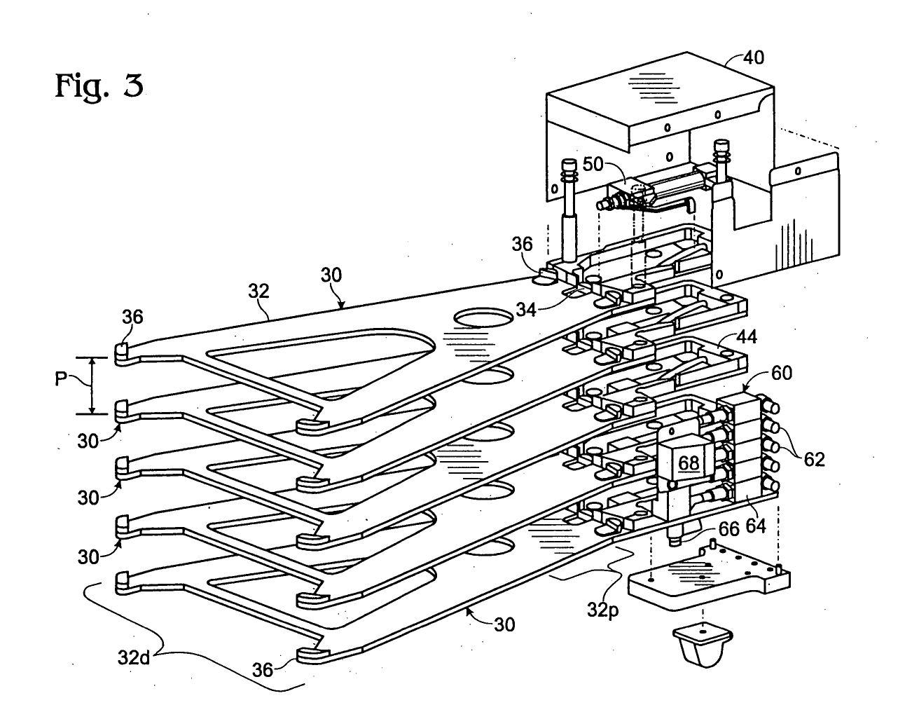

The hand 20 includes a plurality of end effectors 30. Turning attention to FIG. 3, the plurality of end effectors include a plurality of blades 32 with at least one wafer-engaging pad 34 disposed on each blade. The wafer-engaging pad 34 is structured to releasably grasp a wafer W adjacent a peripheral edge thereof. Preferably, the wafer-engaging pad is structured to retain a releasably grasped wafer during a multi-planar movement of the hand.

Each end effector 30 further includes at least one wafer rest pad 36 disposed on the blade 32. The wafer rest pad 36 is configured to support a wafer W adjacent a peripheral edge thereof. The wafer rest pad 36 can be disposed adjacent a proximal end 32p of the blade 32 or adjacent a distal end 32d of blade 32.

The end effectors 30 are structured to securely retain a plurality of grasped wafers W during multi-axial movement of the hand 20 and while undergoing acceleration or deceleration. Wafer grasping is performed by mechanically grasping each of a selected number of wafers only at a peripheral zone thereof. As used herein, “mechanically” grasping refers to wafer engagement by other than by application of pneumatic force directly to a surface of a wafer.

As further seen in FIG. 3, each end effector 30 further includes a wafer sensor 50 (dashed lines). The wafer sensor 50 is operative to sense a wafer W adjacent the blade 32 of the end effector 30. The wafer sensor 50 preferably is an optical wafer sensor, although a mechanical wafer sensor also can be efficaciously employed.

The wafer sensor 50 is structured to sense the presence of a wafer and its position in at least one axis, and preferably can sense a peripheral zone of the wafer when such peripheral zone is proximate or adjacent the hand.

In the embodiment illustrated herein, wafer-engaging pad 34 operates as a wafer contact pad. A mechanical wafer sensor is structured to detect displacement of the wafer contact pad when the wafer contact pad contacts a peripheral zone of a wafer W.

An optical wafer sensor also can be employed, operative to optically detect displacement of the wafer contact pad when the contact pad contacts a wafer peripheral zone. Alternatively, the optical wafer sensor can sense the presence and position of the plurality of wafers by directly optically sensing a wafer peripheral zone proximate or adjacent the hand.

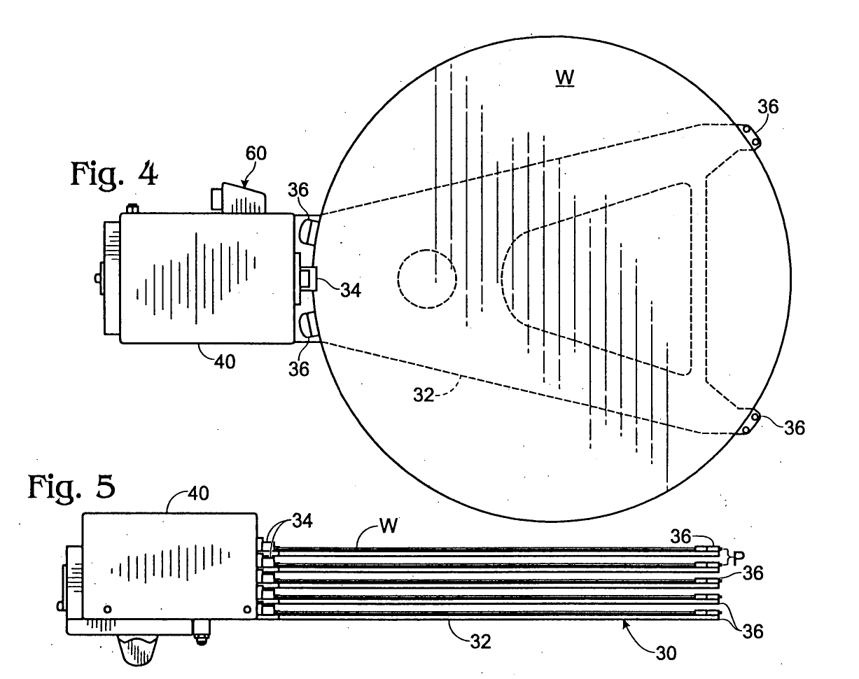

The hand 20 alternatively can further include a body 40 defining an inner cavity housing proximal ends 32p of the plurality of blades 32. In a first alternative embodiment shown in FIGS. 4 and 5, the body 40 can be structured to permit air flow therethrough. This can be achieved by air exhauster 60, which is operative to exhaust air from the body 40 via an air exhaust port 66 communicating with an opening (not visible) of the body.

The air exhauster 60 can include an air exhaust manifold 64, which can be structured to flow air through the body 40 via one or more air inlet ports 62 and the air exhaust port 66 communicating with the body 40. The body 40 can further include a plurality of sub-bodies (not visible in the drawings), each sub-body corresponding to a blade 32 of the plurality of blades. In this embodiment (shown in FIG. 3), an air inlet port 62 is structured to communicate with each sub-body. The air exhauster 60 is operative to flow air through sub-bodies through air inlet ports 62 and air exhaust port 66.

Air exhaust is not limited to this arrangement, however, but can be equivalently achieved by exhausting air from a mechanical device (e.g., a piston-like cylinder as shown in FIG. 3). In addition, a check valve 68 can be employed to regulate air flow through the air exhauster 60.

The plurality of end effectors 30 are configured to have an selected pitch P therebetween, as shown most clearly in FIG. 5. The selected pitch renders the plurality of end effectors 30 suitable for interdigitation with a plurality of wafers W in a multi-wafer receptacle 100, represented in FIG. 1. Multi-wafer receptacles are well-known to those in the art.

The spacing between the center-lines of adjacent wafers W of the plurality of wafers W in the multi-wafer receptacle 100 is at least about 5 mm. In the preferred embodiment based on existing industry standards, the spacing between the wafer center-lines of adjacent wafers of the plurality of wafers in the multi-wafer receptacle is about 10 mm.

The hand 20 can be further equipped with a spacer 44 (FIG. 3) positioned between any two adjacent end effectors 30. The spacer 44 is structured to produce a selected pitch P between these end effectors. The spacers can be changeable, to permit the pitch P to be modified as desired.

Each end effector 30 preferably is structured to uniformly position a geographic center of an engaged wafer W relative to the engaging end effector 30. To accomplish this, each end effector 30 can further be provided a second wafer rest pad 36. The first wafer rest pad 36 and second wafer rest pad 36 preferably are disposed on the distal end 32d of the blade 32.

To move a plurality of wafers W, the plurality of end effectors 30 of the robotic hand 20 are positioned adjacent a first wafer receptacle 100 having arrayed therein a plurality of wafers W.

The hand 20 is inserted into the first wafer receptacle 100, and a selected number of wafers W are mechanically grasped by a corresponding number of end effectors 30. As described above, grasping is accomplished by engagement of one or more of wafers W by the wafer-engaging pad 34 and the wafer rest pad 36.

The hand 20 then is withdrawn from the first wafer receptacle 100, with the selected number of wafers W grasped and retained by the hand 20.

The hand 20 can then be moved to position it adjacent a second wafer receptacle 110 (FIG. 1), and inserted into the second wafer receptacle. Thereupon, the selected number of wafers W are released by deactuation of the grasping mechanism, arraying the wafers in the second wafer receptacle.

The selected number of wafers can, for the embodiment of the hand as described herein, be from one to five wafers, inclusive. One of ordinary skill will readily appreciate that additional end effectors 30 can be provided to increase the maximum number of wafers that can be handled by the hand 20.

Wafer sensors 50 allow the hand 20 to sense the presence of the selected number of wafers W in the first wafer receptacle 100. As discussed above, sensing a wafer can by accomplished by an mechanical, optical or opto-mechanical sensor.

The multi-wafer robotic hand overcomes problems and offers advantages over conventional wafer transfer devices. Importantly, a plurality of wafers can be grasped and retained while undergoing high acceleration and deceleration in the work area. The present hand permits control of multiple wafers, by mechanically gripping the edges thereof, while the hand and retained wafers undergo movement in any plane in space.

The hand disclosed herein is structured to grasp each wafer at a peripheral edge thereof. By using a mechanical retention scheme rather than application of negative pressure (vacuum) to the underside of the wafer, the present hand contacts a wafer in a significantly reduced area. The risk of damage to the wafer is thereby minimized.

In transferring a plurality of wafers, a multi-wafer handler must be structured such that its end effector blades can be interdigitated between the wafers. Standardized wafer containers (e.g., a front-opening unified pod or wafer cassette) currently have a 10 mm pitch between 300 mm wafer centers, limiting the thickness of the blades and grasping mechanisms thereon.

By appropriate design of the wafer-engaging pad and the wafer rest pad, the present hand can be adapted for use with wafer containers having a pitch other than 10 mm. The hand can thereby be customized for proprietary containers or to conform to changing standards.

Further, reduced wafer contact concomitantly lessens the risk of abrading the wafer and generating contaminant micro-particles thereby.

The robot having a hand as disclosed herein allows simultaneous transfer of multiple wafers in a confined volume, which is advantageous from a throughput perspective, while also not requiring an increase in workspace.

Finally, the air exhauster of the hand can be structured as described to remove contaminant particles generated by components, so that such particles are directed away from the wafer-handling area.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and sub-combinations of the various elements, features, functions and/or properties disclosed herein.

What is claimed is:

1. A multi-wafer robotic hand, comprising:
a plurality of end effectors, each of said end effectors including:
a blade, and
at least one wafer-engaging pad disposed on said each blade;
the at least one wafer-engaging pad structured to releasably grasp a wafer adjacent a peripheral edge thereof.

2. The hand of claim 1 wherein said wafer-engaging pad is structured to retain a grasped wafer during multi-planar movement of the hand.

3. The hand of claim 1 wherein each blade has disposed thereon at least one wafer rest pad configured to support a wafer adjacent a peripheral edge thereof.

4. The hand of claim 3 wherein said rest pad is disposed adjacent a proximal end of said blade.

5. The hand of claim 1 wherein said wafer-engaging pad is disposed adjacent a distal end of said blade.

6. The hand of claim 1 wherein the hand further includes a wafer sensor.

7. The hand of claim 6 wherein the wafer sensor is operative to sense a wafer adjacent a blade.

8. The hand of claim 6 wherein the wafer sensor is an optical wafer sensor.

9. The hand of claim 1, further comprising a body defining an inner cavity housing proximal ends of the plurality of blades.

10. The hand of claim 9 wherein the body includes a plurality of subbodies, each sub-body corresponding to a blade.

11. The hand of claim 10 wherein the body includes an air exhauster operative to exhaust air from a sub-body via an air exhaust port communicating with the sub-body.

12. The hand of claim 9 wherein the body is structured to permit negative air flow therethrough.

13. The hand of claim 9 wherein the air exhauster includes an air exhaust manifold.

14. The hand of claim 13 wherein the air exhaust manifold is structured to flow air out of the body via a plurality of air exhaust ports communicating with the body.

15. The hand of claim 1 wherein the plurality of blades are configured to have a pitch suitable for interdigitation with a plurality of wafers in a multi-wafer receptacle.

16. The hand of claim 15 wherein the pitch between the plurality of blades is at least about 5 mm.

17. The hand of claim 15 wherein the pitch between the plurality of blades is 10 mm.

18. The hand of claim 15, further comprising a spacer between any two adjacent blades of the plurality of blades, the spacer producing a pitch therebetween.

19. The hand of claim 18 wherein the spacer is changeable.

20. The hand of claim 1 wherein end effectors are structured to securely retain a plurality of grasped wafers during multi-axial movement of the hand.

21. The hand of claim 1 wherein each effector is structured to uniformly position a geographic center of an engaged wafer relative to an engaging blade.

22. The hand of claim 21 wherein each end effectors further comprises a second wafer rest pad, said first and second wafer rest pads disposed on the distal end of the blade.

23. A robot having a hand structured to grasp and move a plurality of wafers simultaneously, comprising:
a movable arm;
a wrist rotatably mounted on one end of said arm; and
a robotic hand having a plurality of end effectors, each of said end effectors including:
a blade, and
at least one wafer-engaging pad disposed on said each blade;
the at least one wafer-engaging pad structured to releasably grasp a wafer adjacent a peripheral edge thereof.

24. The robot of claim 23 wherein said hand is structured to retain one or more grasped wafers during multi-planar movement.

25. The robot of claim 23 wherein the hand has at least one wafer rest pad disposed on a blade thereof and configured to support a wafer adjacent a peripheral edge thereof.

26. The robot of claim 24, further comprising a wafer sensor.

27. The robot of claim 26 wherein the wafer sensor is operative to sense a wafer adjacent a blade.

28. The robot of claim 23 wherein the hand is structured to permit air flow through a cavity thereof.

29. The robot of claim 28, further comprising an air exhauster operative to exhaust air via an air exhaust port communicating with the cavity.

30. The robot of claim 29 wherein an air exhaust manifold is structured to permit air flow out of the body via a plurality of air exhaust ports communicating with the cavity.

31. The robot of claim 23 wherein the plurality of end effectors are configured to have a pitch suitable for interdigitation with a plurality of wafers in a multi-wafer receptacle.

32. The robot of claim 31 wherein the pitch between the plurality of end effectors is at least about 5 mm.

33. The robot of claim 31 wherein the pitch between the plurality of end effectors is 10 mm.

34. The robot of claim 31, further comprising a spacer between any two adjacent end effectors of the plurality of end effectors, the spacer producing a pitch therebetween.

35. The robot of claim 34 wherein the spacer is changeable.

36. A method for moving a plurality of wafers, comprising:
positioning a plurality of blades of a robotic hand adjacent an opening of a first wafer receptacle having a plurality of wafers arrayed therein;
inserting the hand into the first wafer receptacle;
mechanically grasping a selected number of wafers by a corresponding number of blades;
withdrawing the hand from the first wafer receptacle;
positioning the hand adjacent an opening of a second wafer receptacle;
inserting the hand into the second wafer receptacle; and
releasing the selected number of wafers into the second wafer receptacle.

37. The method of claim 36 wherein the selected number of wafers is one of one, two, three, four, or five wafers.

38. The method of claim 36, further comprising sensing the presence of the selected number of wafers in the first wafer receptacle.

39. The method of claim 38 wherein sensing the presence and position of the plurality of wafers comprises sensing a wafer peripheral zone proximate the hand.

40. The method of claim 39 wherein sensing of wafer comprises detecting a displacement of a wafer contact pad when said wafer contact pad contacts a wafer peripheral zone.

41. The method of claim 39 wherein optically sensing the wafer comprises optically detecting a displacement of a wafer contact pad when said wafer contact pad contacts a wafer peripheral zone.

42. The method of claim 38 wherein sensing the presence and position of the plurality of wafers comprises optically sensing a wafer peripheral zone proximate the hand.

43. The method of claim 36 wherein mechanically grasping a selected number of wafers comprises mechanically grasping each wafer only at a peripheral zone thereof.

44. The method of claim 36 wherein releasing the selected number of wafers comprises arraying the wafers in the second wafer receptacle.
